(19) United States
(12) Patent Application Publication
(10) Pub. No.: US 2025/0191266 A1
(43) Pub. Date: Jun. 12, 2025

(54) VIRTUAL CHARACTER SWITCHING METHOD AND APPARATUS, DEVICE, AND STORAGE MEDIUM

(71) Applicant: Tencent Technology (Shenzhen) Company Limited, Shenzhen (CN)

(72) Inventor: Yan Wang, Shenzhen (CN)

(21) Appl. No.: 19/052,597

(22) Filed: Feb. 13, 2025

Related U.S. Application Data
(63) Continuation of application No. PCT/CN2024/071993, filed on Jan. 12, 2024.

(30) Foreign Application Priority Data
Mar. 6, 2023 (CN) 2023102521981

(51) Int. Cl. G06T 13/40; A63F 13/57

(52) U.S. Cl. CPC G06T 13/40; A63F 13/57

(57) ABSTRACT

This application provides a virtual character switching method and apparatus, a device, and a storage medium. The method comprises: displaying a virtual character in a first style constructed based on first attribute data, an action of the virtual character in the first style being controlled by a controller. The first attribute data is associated with the virtual character in the first style. The method further comprises obtaining second attribute data in response to a switching operation in a process of displaying the virtual character in the first style. The second attribute data is associated with the virtual character in a second style different from the first style. The method further comprises replacing the first attribute data with the second attribute data; and switching the virtual character in the first style to the virtual character in the second style.

### CROSS-REFERENCE TO RELATED APPLICATIONS

This application is a continuation application of PCT Application, filed Jan. 12, 2024, which claims priority to Chinese Patent Application No. 2023102521981 filed on Mar. 6, 2023, each entitled “VIRTUAL CHARACTER SWITCHING METHOD AND APPARATUS, DEVICE, AND STORAGE MEDIUM”, and each of which is incorporated herein by reference in its entirety.

### FIELD OF THE TECHNOLOGY

This application relates to the field of computer technologies, and in particular, to a virtual character switching method and apparatus, a device, and a storage medium.

### BACKGROUND OF THE DISCLOSURE

In a game, a player usually needs to switch a controlled virtual character, and switch the currently controlled virtual character to another virtual character.

In the related art, switching of a virtual character is equivalent to reinitializing and loading a new virtual character. To be specific, data of the new virtual character needs to be loaded, a new controller needs to be created, and then the newly created virtual character is controlled through the new controller.

However, the foregoing switching process may result in a lack of smooth switching between virtual characters.

### SUMMARY

This application provides a virtual character switching method and apparatus, a device, and a storage medium. The technical solutions are as follows.

According to an aspect of this application, a virtual character switching method is provided, the method being performed by a computing device, and comprising:
displaying a virtual character in a first style constructed based on first attribute data, an action of the virtual character in the first style being controlled by a first controller, and the first attribute data is associated with the virtual character in the first style;
obtaining second attribute data in response to a switching operation in a process of displaying the virtual character in the first style, the second attribute is associated with the virtual character in a second style, the second style being different from the first style;
replacing the first attribute data with the second attribute data; and
switching the virtual character in the first style to the virtual character in the second style constructed based on the second attribute data, an action of the virtual character in the second style being controlled by the first controller.

According to an aspect of this application, a virtual character switching apparatus is provided, the apparatus including:
a display module, configured to display a virtual character in a first style constructed based on first attribute data, an action of the virtual character in the first style being controlled by a first controller, and the first attribute data is associated with the virtual character in the first style;
an obtaining module, configured to obtain second attribute data in response to a switching operation in a process of displaying the virtual character in the first style, the second attribute data is associated with the virtual character in a second style, the second style being different from the first style;
a replacing module, configured to replace the first attribute data with the second attribute data; and
a switching module, configured to switch the virtual character in the first style to the virtual character in the second style constructed based on the second attribute data, an action of the virtual character in the second style being controlled by the first controller.

According to an aspect of this application, a terminal device is provided, the memory having a computer program stored therein, the computer program being loaded and executed by the processor to implement the foregoing virtual character switching method.

According to an aspect of this application, a non-transitory computer-readable storage medium is provided, having a computer program stored therein, the computer program being loaded and executed by a processor to implement the foregoing virtual character switching method.

According to an aspect of this application, a computer program product is provided, the computer program product including a computer program, the computer program being loaded and executed by a processor to implement the foregoing virtual character switching method.

The technical solutions provided in this application may bring the following beneficial effects. The virtual character in the first style is switched to the virtual character in the second style by replacing the attribute data of the virtual character without changing the controller of the virtual character. Compared with the related art in which a new controller needs to be created, and overall data of the virtual character in the second style needs to be reloaded to replace overall data of the virtual character in the first style, causing a problem of unsmooth switching in a switching process, in an example of this application, the virtual character is controlled through the same controller before and after the switching, and the control system does not change except for a change in the style of the virtual character, thereby omitting an operation of replacing the entire control system. Therefore, the problem of unsmooth character switching may be avoided while implementing style switching of the virtual character, thereby realizing seamless switching of the virtual character between different styles, and improving a switching effect.

### BRIEF DESCRIPTION OF THE DRAWINGS

FIG. 1 is a schematic diagram of a solution implementation environment according to an example of this application.

FIG. 2 is a flowchart of a virtual character switching method according to an example of this application.

FIG. 3 is a schematic diagram of a user interface (UI) for a user to switch a virtual character according to an example of this application.

FIG. 4 is a diagram showing an effect of replacing bone data and model data according to an example of this application.

FIG. 5 is a schematic diagram of a switched virtual character according to an example of this application.

FIG. 6 is a flowchart of obtaining second attribute data according to an example of this application.

FIG. 7 is a schematic diagram of obtaining second exclusive bone data according to an example of this application.

FIG. 8 is a schematic diagram showing that a client replaces model data according to an example of this application.

FIG. 9 is a schematic diagram showing that a client replaces attribute data according to an example of this application.

FIG. 10 is a block diagram of a virtual character switching apparatus according to an example of this application.

FIG. 11 is a structural block diagram of a terminal device according to an example of this application.

### DESCRIPTION OF EXAMPLES

To make the objectives, technical solutions, and advantages of this application clearer, the following further describes implementations of this application in detail with reference to the accompanying drawings.

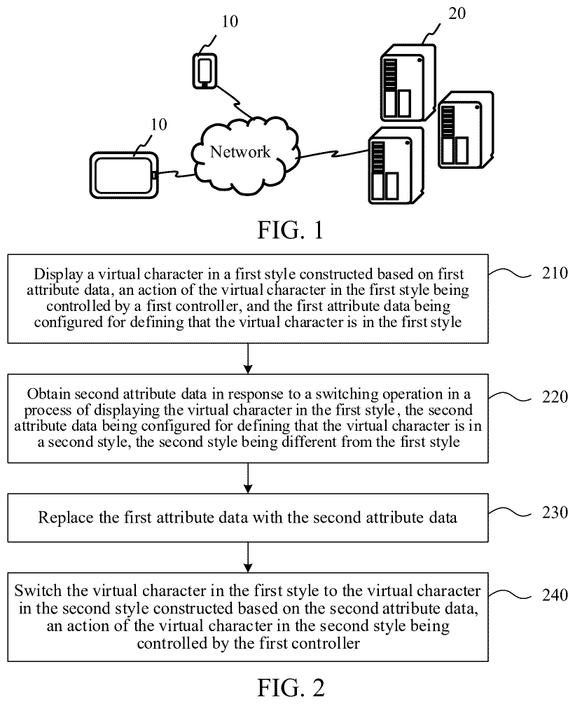

FIG. 1 is a schematic diagram showing a solution implementation environment according to an example of this application. The solution implementation environment may be implemented as a virtual character switching system. The solution implementation environment may include a terminal device 10 and a server 20.

One or more terminal devices 10 may be provided. The terminal device 10 may be an electronic device such as a mobile phone, a tablet computer, a game console, an e-book reader, a multimedia playback device, a wearable device, a personal computer (PC), and an on-board terminal. A client of a target application (such as a game application or an extended reality (XR) application) may be installed in the terminal device 10. In some examples, the target application may be an application that needs to be downloaded and installed, or may be a click-to-run application, which is not limited in this application.

In an example of this application, the target application may be a game application, including a shooting application, a racing application, a multiplayer online tactical arena game, and the like, which is not limited in this application. In some examples, the foregoing game application can provide a virtual environment for a virtual character that a user substitutes for and operates to perform an activity in the virtual environment, such as walking, jumping, crawling, or fighting. The virtual environment is an environment displayed (or provided) when an application runs on the terminal device. For different applications, forms or shapes of virtual characters provided by the different applications may also be different, and corresponding functions may also be different. These may be designed according to actual requirements. This is not limited in this application. In some examples, a client of the foregoing application runs on the terminal device 10. In some examples, the foregoing application is an application developed based on a three-dimensional virtual environment engine. For example, the virtual environment engine may be an unreal engine 4 (UE 4), a unity engine, or the like. The virtual environment engine can construct a three-dimensional virtual environment, a virtual character, a virtual prop, and the like, bringing more immersive game experience to a user.

The foregoing virtual environment refers to a scene created for the virtual character to perform activities (such as game competition), for example, a virtual house, a virtual island, or a virtual map. The virtual environment may be a simulated world of a real world, or may be a semi-simulation and semi-fiction three-dimensional world, and may further be a purely fictional three-dimensional world. The virtual environment may be any one of a two-dimensional virtual environment, a 2.5-dimensional virtual environment, and a three-dimensional virtual environment.

The foregoing virtual character refers to a movable object in the virtual environment controlled by a controller of the client, which may be at least one of a virtual character, a virtual animal, or a cartoon character. In some examples, when the virtual environment is the three-dimensional virtual environment, the virtual character may be a three-dimensional virtual model. Each virtual character has a shape and a volume in the three-dimensional virtual environment, and occupies a partial space in the three-dimensional virtual environment. In some examples, the virtual character is a three-dimensional character constructed based on a three-dimensional human bone technology. The virtual character realizes different external appearances by wearing different skins. In some implementations, the virtual character may also be implemented through a 2.5-dimensional model or 2-dimensional model, which is not limited in this application. For example, the target application is the game application. The virtual character refers to a game character controlled by a user account in the game application. The virtual character may be in a human form, an animal form, a cartoon form, or another form, which is not limited in this application.

The server 20 is configured to provide a background service for the client of the target application installed and running on the terminal device 10. For example, the server 20 may be a background server of the foregoing game application. The server 20 may be one server, a cluster of servers formed by a plurality of servers, or a cloud computing service center. In some examples, the server 20 is configured to provide background services for the target application in a plurality of terminal devices 10 simultaneously. The terminal device 10 may communicate with the server 20 through a network.

In this example of this application, the controller of the client may be configured to control the virtual character to complete different behaviors or actions in the virtual environment. When the user needs to switch a display style of the controlled virtual character, for example, switch clothes of the virtual character, switch a form of the virtual character, or switch an identity of the virtual character, a virtual character that is displayed in a first style and that is controlled by the user may be switched to a virtual character displayed in a second style by triggering a switching key. In addition, when the display styles of the virtual characters are switched, the virtual characters before and after switching are controlled through the same controller, so that a problem of unsmooth switching does not occur during the switching of virtual characters.

FIG. 2 is a flowchart showing a virtual character switching method according to an example of this application. An execution subject of operations of the method may be the terminal device 10 in the solution implementation environment shown in FIG. 1. For example, the execution subject of the operations may be a client of a target application. In the following method examples, for ease of description, a description is provided by using an example in which each operation is performed by a “client”. The method may include at least one operation of operation 210 to operation 240 below.

Operation 210: Display a virtual character in a first style constructed based on first attribute data, an action of the virtual character in the first style being controlled by a first controller, and the first attribute data being configured for defining that the virtual character is in the first style.

The first attribute data refers to various feature data of the virtual character required for the virtual character to be displayed in the first style, which may be configured for characterizing various character features of the virtual character in the first style, including a bone feature, a model feature, an animation feature, and the like of the virtual character. The first attribute data includes first bone data, first model data, and first animation data.

The first style refers to any style in which a virtual character is displayed in a virtual environment. Different types of virtual characters may present several different styles, and the same type of virtual character may also present several different styles. The different styles presented by the virtual characters may also be referred to as different genres of the virtual characters. In other words, the first style may also be referred to as a first genre. The same type of virtual character presents several different styles, and may present several different styles through different categories such as an identity and a gender of the virtual character. For example, a virtual character in a human form is a type of virtual character, and a virtual character in an animal form is another type of virtual character. The virtual character in the human form may include a plurality of categories such as male, female, warrior, doctor, and student. The virtual character in the animal form may include a plurality of categories such as tiger, lion, and antelope. A virtual character of the warrior category may be presented in a plurality of styles such as an archer, a swordsman, and a fencer. When the virtual character only serves as an archer, different styles may be presented based on settings such as different clothes, hair styles, and expressions. The plurality of styles under the warrior category are all obtained based on the virtual character in the human form.

The first controller is a controller for the virtual character in the first style. The client may control the first controller on the client to control the action of the virtual character in the first style, for example, may control the virtual character to perform an action such as jumping, walking, turning, or fighting. In some examples, the first controller is configured to control each bone of the virtual character, so as to control the action of the virtual character by controlling the bone. In some examples, the first controller is configured to control each muscle of the virtual character, so as to control the action of the virtual character by controlling the muscle. A specific form of the first controller is not limited in this example of this application. In this example of this application, no matter how the style of the virtual character changes, the same controller is always maintained. In other words, in a case that the controller is not changed, actions of virtual characters in different styles can be controlled.

In some examples, the first attribute data includes the first bone data. The first bone data is obtained by adjusting basic bone data based on first exclusive bone data, the first exclusive bone data is exclusive bone data corresponding to the first style, and bone data is configured for constructing a body shape skeleton of the virtual character.

The bone data is configured for constructing the body shape skeleton of the virtual character. The basic bone data refers to basic data required to construct the body shape skeleton of the virtual character. Basic bone data of the same type of virtual character presented in different styles is the same, and basic bone data of different types of virtual characters presented in different styles is different. For example, basic bone data of virtual characters in the human form is the same, which is all basic bone data generated based on a three-dimensional human bone technology. However, the basic bone data of the virtual characters in the human form is different from basic bone data of the virtual character in the animal form.

The first exclusive bone data is unique bone data when the virtual character is presented in the first style. In some examples, the first exclusive bone data may be bone data corresponding to the first style, which is configured for indicating a body shape or a skeleton unique to the virtual character in the first style. For example, the first exclusive bone data may include a skeleton length corresponding to a height of the virtual character in the first style, bone hardness of the virtual character in the first style, a skeleton thickness of the virtual character in the first style, and the like. In some examples, virtual characters in different styles correspond to different exclusive bone data. In some examples, a server of the target application has exclusive bone data respectively corresponding to the virtual characters in different styles recorded therein.

The first bone data refers to complete bone data required to construct the body shape skeleton of the virtual character displayed in the first style. Virtual characters constructed based on the first bone data have the same body shape feature. For example, the virtual characters have the same skeleton feature such as the same height, the same head circumference, or the same arm length.

After a character type to which the virtual character belongs is determined, for example, after it is determined that the virtual character is a virtual character in a human form, it may be determined that the basic bone data of the virtual character is basic bone data of the human form. The basic bone data of the human form is copied to obtain copy bone data that is based on the basic bone data of the human form. Then the copy bone data obtained through copying is modified and adjusted based on the first exclusive bone data corresponding to the first style, to obtain first bone data.

In some examples, the first attribute data further includes first model data, the first model data being model data corresponding to the first style, the model data being configured for defining an appearance of the virtual character.

The first model data refers to appearance data needed to construct the appearance of the virtual character displayed in the first style, and may include data corresponding to another item attached to the virtual character, such as a hair style, clothes, an accessory, or a prop of the virtual character.

In some examples, the first attribute data further includes first animation data, the first animation data being animation data corresponding to the first style, the animation data being configured for defining the action of the virtual character.

The first animation data is action data that maintains a matching degree and smoothness between the action of the virtual character displayed in the first style and the action controlled by the client by the first controller. The first animation data is related to the first bone data and an action state of the virtual character when switched to the first style. If the virtual character presents a jumping state when a display style of the virtual character is switched from another style to the first style, the first animation data is animation data related to the jumping state obtained from an animation database corresponding to the first style. If the virtual character presents a walking state when the display style of the virtual character is switched from another style to the first style, the first animation data is animation data related to the walking state obtained from the animation database corresponding to the first style.

The virtual character presented in the first style may be constructed based on the first bone data, the first model data, and the first animation data. The action of the virtual character presented in the first style may be controlled by controlling the first controller on the client.

Operation 220: Obtain second attribute data in response to a switching operation in a process of displaying the virtual character in the first style, the second attribute data being configured for defining that the virtual character is in a second style, the second style being different from the first style.

The second attribute data refers to various feature data of the virtual character required for the virtual character to be displayed in the second style, which may be configured for characterizing various character features of the virtual character in the second style, including a bone feature, a model feature, an animation feature, and the like of the virtual character. The second attribute data includes second bone data, second model data, and second animation data. The second style refers to any style other than the first style in which the virtual character is displayed in the virtual environment.

The switching operation is an operation implemented by a user. The client may generate a corresponding switching instruction based on the switching operation of the user, so that the client may obtain the second attribute data based on the switching instruction.

In some examples, the switching operation may be an operation in which the user triggers a shortcut key. For example, if the user controls the first controller on the client through a keyboard, the shortcut key may be a tab key on the keyboard, or may be a Ctrl key+any letter key or number key on the keyboard, or the like.

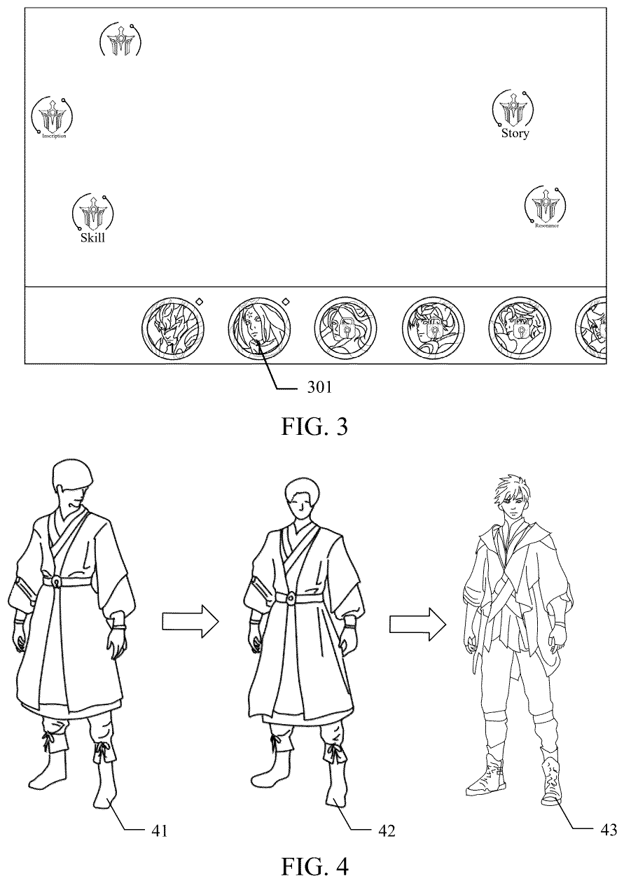

In some examples, the switching operation may be that the user clicks the virtual character in the second style on a user interface (UI) of the client, as shown in FIG. 3. The user clicks on the UI interface for switching virtual characters in different styles. Several avatars 301 of virtual characters in different styles are displayed on the UI interface, and the user may click/tap any one of the avatars 301 to complete the switching operation. In the avatars 301 shown in FIG. 3, currently, there are only two avatars that the user can select to switch, and another style of the virtual character may be unlocked to complete a corresponding task requirement, thereby implementing switching of more styles of virtual characters.

However, in the foregoing manner of completing the switching operation by triggering the shortcut key by the user, a desired style may not be selected. In response to the operation of triggering the shortcut key by the user, the client may obtain attribute data corresponding to a preset style after the first style. However, in response to an operation of clicking/tapping, by the user, a virtual character in any style on the UI interface, the client may obtain attribute data corresponding to any style. If the user wants to switch to a virtual character in a specific style, in the manner of completing the switching by triggering a shortcut key, the user may need to perform a plurality of switching operations before switching to the virtual character in the specific style. However, switching to the virtual character in the specific style may be achieved at one time in the manner of triggering a virtual character in a specific style on the UI interface.

In some examples, in the process of controlling, by the first controller, the virtual character in the first style to move, the second attribute data is obtained in response to the switching operation. Alternatively, in the process of controlling, by the first controller, the virtual character in the first style to fight, the second attribute data is obtained in response to the switching operation.

Fight refers to that the virtual character in the first style that is controlled by the first controller is in a process of matching or fighting with a virtual character controlled by another controller. Move refers to that the virtual character in the first style that is controlled by the first controller is in another state other than a fight state.

A moment at which the client responds to the switching operation is not specifically limited in this application. For example, the moment at which the client responds to the switching operation may be in the process of controlling, by the first controller the virtual character in the first style to move, or may be in the process of controlling, by the first controller, the virtual character in the first style to fight. In the process of controlling, by the first controller, the virtual character in the first style to perform any action or behavior, the client may obtain the second attribute data corresponding to the second style in response to the switching operation triggered by the user.

It is enumerated that in the process in which the first controller controls the virtual character in the first style to move and fight, the second attribute data may be obtained in response to the switching operation, which indicates that an occasion of responding to the switching operation by the client is not limited in this application. The virtual character in the first style may complete style switching when performing any behavior. Therefore, in this example of this application, when the virtual character in the first style performs any behavior, the second attribute data may be obtained in response to the switching operation, thereby enriching ways to obtain the second attribute data and improving style switching efficiency.

Operation 230: Replace the first attribute data with the second attribute data.

The corresponding first bone data, first model data, and first animation data are respectively replaced with the second bone data, the second model data, and the second animation data, to implement a process of replacing the first attribute data with the second attribute data. The replacement process is shown in FIG. 4. FIG. 4 shows a process of replacing the corresponding first bone data and first model data with the second bone data and the second model data, so that the appearance of the virtual character is switched from the first style to the second style. The first bone data is replaced with the second bone data, so that a virtual character 41 in a first style in FIG. 4 is converted into a virtual character 42 in a transition state. The virtual character 42 in the transition state has changed in a body shape skeleton compared with the virtual character 41 in the first style. Then the first model data is replaced with the second model data, so that the virtual character 42 in the transition state in FIG. 4 is converted into a virtual character 43 in a second style. Compared with the virtual character 42 in the transition state, the virtual character 43 in the second style has changed in appearance such as clothes and a hair style. Then the first animation data is replaced with the second animation data, so that action smoothness of the virtual character displayed in the second style after the replacement remains unchanged and matches the action state of the virtual character displayed in the first style before the replacement.

In some examples, the second bone data included in the second attribute data may be the same or different from the first bone data included in the first attribute data.

If the second bone data included in the second attribute data is the same as the first bone data included in the first attribute data, it first indicates that a type of the virtual character corresponding to the second bone data is the same as a type of the virtual character corresponding to the first bone data. For example, the types of the virtual characters are both the virtual characters in the human form. Next, it indicates that a body shape skeleton of the virtual character corresponding to the second bone data is the same or similar to a body shape skeleton of the virtual character corresponding to the first bone data. In terms of an appearance feature, a height, an arm length, a skull structure, and the like of the virtual character in the second style are the same or similar to those of the virtual character in the first style. To be specific, it is commonly known that the appearance, the height, and the like are the same or similar.

If the second bone data included in the second attribute data is the different from the first bone data included in the first attribute data, it may indicate that the type of the virtual character corresponding to the second bone data is the same as the type of the virtual character corresponding to the first bone data, or it may indicate that the type of the virtual character corresponding to the second bone data is different from the type of the virtual character corresponding to the first bone data. When the type of the virtual character corresponding to the second bone data is the same as the type of the virtual character corresponding to the first bone data, for example, the two virtual characters are both virtual characters in the human form, the body shape skeleton of the virtual character corresponding to the second bone data is different from the body shape skeleton of the virtual character corresponding to the first bone data. In terms of the appearance feature, the height, the arm length, the skull structure, and the like of the virtual character in the second style are different from those of the virtual character in the first style in at least one aspect. To be specific, a difference exists in the appearance, the height, and the like that can usually be observed. When the type of the virtual character corresponding to the second bone data is different from the type of the virtual character corresponding to the first bone data, for example, the virtual character corresponding to the second bone data may be the virtual character in the human form, and the virtual character corresponding to the first bone data may be the virtual character in the animal form, the body shape skeleton of the virtual character corresponding to the second bone data and the body shape skeleton of the virtual character corresponding to the first bone data are different, and have a significant difference in appearance features.

Operation 240: Switch the virtual character in the first style to the virtual character in the second style constructed based on the second attribute data, an action of the virtual character in the second style being controlled by the first controller.

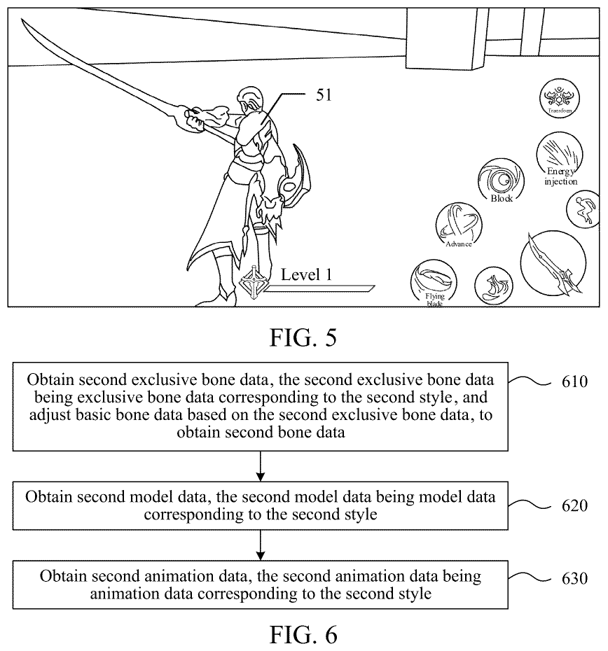

The first attribute data is replaced with the second attribute data, so that the virtual character in the first style may be switched to the virtual character in the second style constructed based on the second attribute data. For the switched virtual character, reference may be made to a UI shown in FIG. 5. The switched virtual character 51 shown in FIG. 5 is in a process of fight, and an action state of the switched virtual character may be connected to an action state of the virtual character in the first style.

A process of switching the virtual character in the first style to the virtual character in the second style is completed in one frame. A switching process completed in one frame herein merely indicates a process of replacing the first attribute data with the second attribute data, and a process of obtaining the second attribute data is not included in the frame. After obtaining the second attribute data in response to the switching operation of the user, the client completes replacement of the attribute data in one frame, to implement a process of switching the virtual character in the first style to the virtual character in the second style. Therefore, in a process of switching from the virtual character in the first style to the virtual character in the second style, a problem of unsmooth switching or switching freezing does not occur, and different styles of the virtual characters can be seamlessly switched.

For the virtual character in the second style after switching, the client may still control the action of the virtual character in the second style by the first controller. The first controller is configured for the controlled virtual character. If the controlled virtual character does not change, only the display style of the virtual character is switched, and the corresponding controller does not need to change either. In the switching process, a control system in which the client controls the virtual character by the first controller substantially does not change.

In the technical solutions provided in the examples of this application, the virtual character in the first style is switched to the virtual character in the second style by replacing the attribute data of the virtual character without changing the controller of the virtual character. Compared with the related art in which a new controller needs to be created, and overall data of the virtual character in the second style needs to be reloaded to replace overall data of the virtual character in the first style, causing a problem of unsmooth switching in a switching process, in the examples of this application, the virtual character is controlled through the same controller before and after the switching, and the control system does not change except for a change in the style of the virtual character, thereby omitting an operation of replacing the entire control system. Therefore, the problem of unsmooth character switching may be avoided while implementing style switching of the virtual character, thereby realizing seamless switching of the virtual character between different styles, and improving a switching effect.

FIG. 6 is a flowchart showing obtaining second attribute data according to an example of this application. The second attribute data includes at least one of second bone data, second model data, and second animation data. The method may include at least one operation of operation 610 to operation 630 below.

Operation 610: Obtain second exclusive bone data, the second exclusive bone data being exclusive bone data corresponding to the second style, and adjust basic bone data based on the second exclusive bone data, to obtain second bone data, the second attribute data including the second bone data, and the second bone data being configured for replacing the first bone data.

The second exclusive bone data is unique bone data when the virtual character is presented in the second style. In some examples, the second exclusive bone data may be bone data corresponding to the second style, which is configured for indicating a body shape or a skeleton unique to the virtual character in the second style. For example, the second exclusive bone data may include a skeleton length corresponding to a height of the virtual character in the second style, a bone hardness of the virtual character in the second style, a skeleton thickness of the virtual character in the second style, and the like.

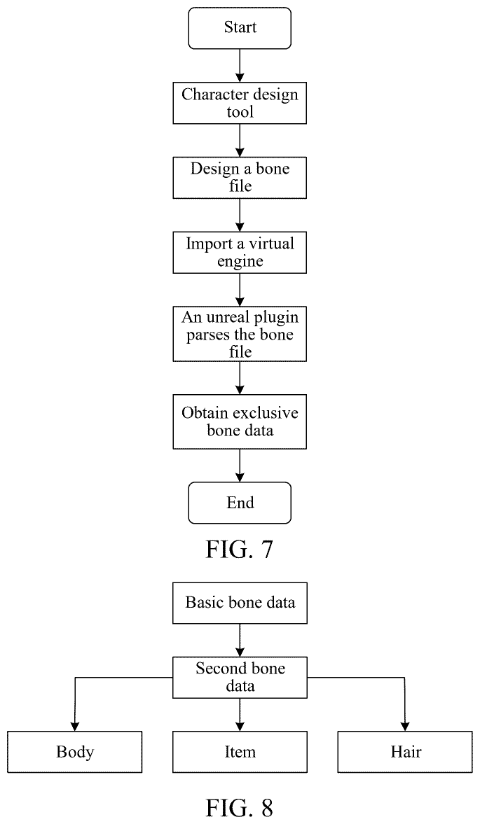

Reference may be made to FIG. 7 for a process of obtaining the second exclusive bone data. For exclusive bone data of each style, bone files corresponding to virtual characters in different styles may be first designed through a character design tool. The character design tool herein may be third-party design software such as MAYA software and Max software. Further, the bone files corresponding to the virtual characters in different styles may be imported into a virtual engine in a certain form. The bone files herein may be stored in a virtual engine in a file form such as JavaScript Object Notation (JSON) or a text format, and the virtual engine may be a virtual engine such as UE 4 or Unity. When a client needs to obtain the second exclusive bone data in response to a switching operation, the client may parse the bone file corresponding to the second exclusive bone data in the virtual engine through an unreal plugin, to obtain the second exclusive bone data.

After the character type to which the virtual character belongs is determined, in other words, after the basic bone data of the virtual character is determined, the basic bone data is replicated to obtain copy bone data based on the basic bone data. Then the copy bone data obtain through replication is modified and adjusted based on the second exclusive bone data corresponding to the second style, to obtain the second bone data.

The second bone data is obtained by adjusting the basic bone data based on the second exclusive bone data, so as to avoid replacing entire data of the virtual character in the second style in the related art. In addition, an effect of changing a body shape skeleton of the virtual character can be achieved, and the operation is faster and more convenient.

In some examples, the feature parameter of the first bone included in the basic bone data is adjusted based on the feature parameter of the first bone included in the second exclusive bone data, to obtain the second bone data. The feature parameter of the first bone is configured for specifying at least one of a size, a shape, a position, and an angle of the first bone.

The first bone is a feature bone owned by virtual characters in various styles, and is a main reason why the virtual characters in various styles are different from virtual characters in other styles. In some examples, the first bone is at least one bone in bones inside the virtual character. For example, the first bone is a head bone, a hand bone, a leg bone, or a torso bone. The feature parameter of the first bone enables the virtual character to be displayed in a specific style, and enables the display style of the virtual character to have a specific body shape feature of the virtual character. The feature parameter of the first bone included in the basic bone data has no distinction and only enables the virtual character to present a display form in an initialized state. However, the feature parameter of the first bone included in the second exclusive bone data enables the virtual character to be displayed in the second style.

The feature parameter of the first bone is configured for specifying at least one of a size, a shape, a position, and an angle of the first bone. For example, the feature parameter of the first bone may specify a bone length and width of the first bone, a shape feature of the first bone, a position, a setting angle, a setting direction, and the like of the first bone in all bones.

First bones corresponding to virtual characters in different styles are not necessarily the same. In a case that the corresponding first bones are the same, feature parameters of the first bones are not necessarily the same. A feature parameter of at least one first bone included in the feature parameters of the first bones corresponding to the virtual characters in various styles is different from a feature parameter of a first bone corresponding to a virtual character in another style. In some examples, in the feature parameters of the first bone corresponding to the virtual character in the second style, only one feature parameter of the first bone corresponding to the virtual character in the second style may be different from the feature parameter of the first bone corresponding to the virtual character in the first style.

After the copy bone data based on the basic bone data is obtained, the feature parameter of the first bone included in the copy bone data is adjusted and modified based on the feature parameter of the first bone included in the second exclusive bone data, to obtain the second bone data.

The feature parameter of the first bone included in the bone data is modified as above, so that complexity of a process of obtaining the second bone data can be reduced and a rate of obtaining the second bone data can be improved, thereby better achieving an effect of seamless switching of the character styles.

Operation 620: Obtain second model data, the second model data being model data corresponding to the second style, the second attribute data including the second model data, and the second model data being configured for replacing the first model data.

The second model data refers to appearance data needed to construct the appearance of the virtual character displayed in the second style, and may include data corresponding to another item attached to the virtual character, such as a hair style, clothes, an accessory, or a prop of the virtual character.

In some examples, each appearance resource included in the second model data replaces each appearance resource included in the first model data through asynchronous loading.

The asynchronous loading means that when data loading processing is performed based on an operation request, another operation may be responded to, and data loading corresponding to the another operation may be performed. For example, when a hair resource in the first model data is replaced with a hair resource in the second model data, a clothes resource in the first model data may be replaced with a clothes resource in the second model data.

The asynchronous loading herein means that the process of replacing each appearance resource included in the second model data with each appearance resource included in the first model data is asynchronously loaded and does not indicate that the process of replacing the first model data by the second model data and the process of replacing the first bone data by the second bone data are asynchronously loaded. Only after the first bone data is replaced with the second bone data, the first model data can be replaced with the second model data.

A specific manner of replacing the first model data with the second model data is to replace each appearance resource corresponding to the first model data through each appearance resource included in the second model data. Reference may be made to FIG. 8 for a specific replacement process. After the second bone data is obtained by adjusting the basic bone data based on the second exclusive bone data, each appearance resource corresponding to the first model data is replaced through each appearance resource included in the second model data. For example, a body-related clothes resource included in the first model data is replaced with a body-related clothes resource included in the second model data. An item-related prop and an accessory resource included in the first model data is replaced with an item-related prop and an accessory resource included in the second model data. A hair-related hairstyle resource included in the first model data is replaced with a hair-related hairstyle resource included in the second model data.

In this example of this application, the second model data is obtained and each appearance resource is replaced through asynchronous loading, which can shorten a time for replacing the first model data with the second model data, improve an efficiency of data replacement, thereby better achieving the effect of seamless switching of the character styles.

Operation 630: Obtain second animation data, the second animation data being animation data corresponding to the second style, the second attribute data including the second animation data, the second animation data being configured for replacing the first animation data.

The second animation data is action data that maintains a matching degree and smoothness between the action of the virtual character displayed in the second style and the action controlled by the client by the first controller. The second animation data is related to the second bone data and an action state of the virtual character when switching from the first style to the second style. The first animation data is replaced with the second animation data. Therefore, when the virtual character switches from the first style to the second style, the second bone data of the virtual character can be compatible with the action of the virtual character during switching, ensuring smooth switching of the actions of the virtual character displayed in the second style and the virtual character displayed in the first style.

In some examples, the obtaining second animation data includes: determining a first action currently performed by the virtual character in the first style; and selecting, as the second animation data, animation data corresponding to the first action from a plurality of pieces of candidate animation data corresponding to the second style, different actions corresponding to different animation data.

A virtual character in each style corresponds to an animation database, the animation database including animation data corresponding to different actions, the different actions corresponding to different animation data. Based on the first action performed by the virtual character in the first style in response to the switching operation, the animation data corresponding to the first action is selected as the second animation data from the plurality of pieces of candidate animation data corresponding to the second style. For example, if the first action performed by the virtual character in the first style is a walking action in response to the switching operation, animation data corresponding to the walking action is selected as the second animation data from the plurality of pieces of candidate animation data corresponding to the second style. If the first action performed by the virtual character in the first style is a jumping action in response to the switching operation, animation data corresponding to the jumping action is selected as the second animation data from the plurality of pieces of candidate animation data corresponding to the second style. A target action in this example of this application refers to at least one of the foregoing different actions. The target action includes but is not limited to jumping, running, squatting, or raising a hand.

Corresponding animation data is selected as the second animation data based on the first action performed by the virtual character in the first style in response to the switching operation, so as to better ensure a matching degree of actions of the virtual character during style switching, thereby improving smoothness of the actions during switching.

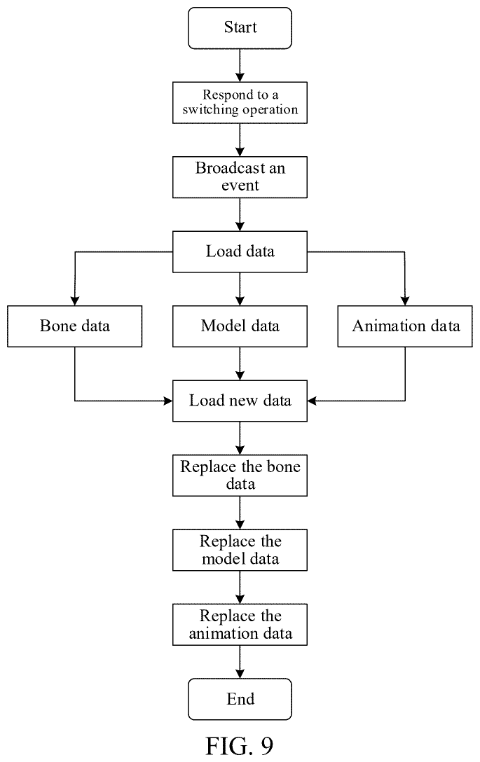

The operation of obtaining the second animation data, the operation of obtaining the second bone data, and the operation of obtaining the second model data may be performed synchronously. The operation of replacing the second bone data, the operation of replacing the second model data, and the operation of replacing the second animation data may be separately performed. For a specific process of obtaining data and loading data, reference may be made to FIG. 9. After the client responds to the switching operation triggered by a user, the client synchronously distributes a switching event of the character style to data systems which require a data refresh. A monitoring event is bound to the systems which require a data refresh. When a switching event is detected by the monitoring event, the systems individually load and replace corresponding data. The process of loading the bone data, the model data, and the animation data is performed synchronously. Therefore, the process of loading each piece of attribute data may be synchronously implemented. After the second bone data, the second model data, and the second animation data corresponding to the second style are obtained, each piece of data in the first attribute data is replaced in sequence. First, the first bone data is replaced with the second bone data. After the replacement of the bone data is completed, the first model data is replaced with the second model data, to respectively replace appearance resources such as the body, hair, and items, and refresh appearance performance of the virtual character. After the replacement of the model data is completed, the first animation data is replaced with the second animation data, so that the action smoothness of the virtual character displayed in the second style after the replacement remains unchanged and matches the action state of the virtual character displayed in the first style before the replacement. The user is allowed to implement style switching in any state of the virtual character, and whether in a fighting state or a moving state, requirements of different animation performance can be met while realizing seamless switching of the character styles, thereby avoiding the problem of unsmooth character switching in the related art.

An apparatus example of this application is described below, which may be configured for performing the method example of this application. For details not disclosed in the apparatus example of this application, reference is made to the method examples of this application.

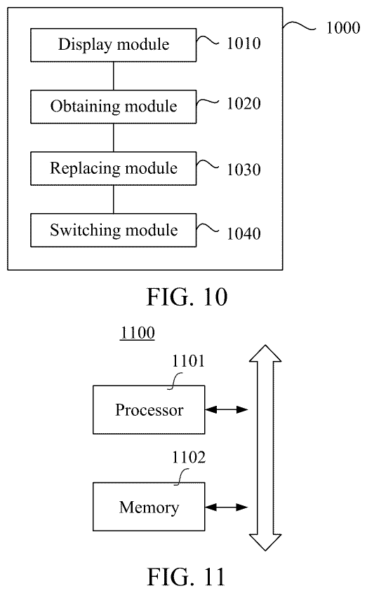

FIG. 10 is a block diagram showing a virtual character switching apparatus according to an example of this application. The apparatus has a function of implementing the foregoing virtual character switching method. The function may be implemented by hardware or by executing corresponding software by hardware. The apparatus may be the terminal device described above, or may be arranged in the terminal device. As shown in FIG. 10, the apparatus 1000 may include a display module 1010, an obtaining module 1020, a replacing module 1030, and a switching module 1040.

The display module 1010 is configured to display a virtual character in a first style constructed based on first attribute data, an action of the virtual character in the first style being controlled by a first controller, and the first attribute data being configured for defining that the virtual character is in the first style.

The obtaining module 1020 is configured to obtain second attribute data in response to a switching operation in a process of displaying the virtual character in the first style, the second attribute data being configured for defining that the virtual character is in a second style, the second style being different from the first style.

The replacing module 1030 is configured to replace the first attribute data with the second attribute data.

The switching module 1040 is configured to switch the virtual character in the first style to the virtual character in the second style constructed based on the second attribute data, an action of the virtual character in the second style being controlled by the first controller.

In some examples, the first attribute data includes the first bone data. The first bone data is obtained by adjusting basic bone data based on first exclusive bone data, the first exclusive bone data is exclusive bone data corresponding to the first style, and bone data is configured for constructing a body shape skeleton of the virtual character. The obtaining module 1020 includes: a first obtaining unit, configured to obtain second exclusive bone data, the second exclusive bone data being exclusive bone data corresponding to the second style; and an adjustment unit, configured to adjust the basic bone data based on the second exclusive bone data, to obtain second bone data, the second attribute data including the second bone data, and the second bone data being configured for replacing the first bone data.

In some examples, the adjustment unit is configured to:
adjust, based on a feature parameter of a first bone included in the second exclusive bone data, the feature parameter of the first bone included in the basic bone data to obtain the second bone data,
the feature parameter of the first bone being configured for specifying at least one of a size, a shape, a position, and an angle of the first bone.

In some examples, the first attribute data includes first model data, the first model data being model data corresponding to the first style, the model data being configured for defining an appearance of the virtual character. The obtaining module 1020 includes:
a second obtaining unit, configured to obtain second model data, the second model data being model data corresponding to the second style,
the second attribute data including the second model data, and the second model data being configured for replacing the first model data.

In some examples, each appearance resource included in the second model data replaces each appearance resource included in the first model data through asynchronous loading.

In some examples, the first attribute data includes first animation data, the first animation data being animation data corresponding to the first style, the animation data being configured for defining the action of the virtual character. The obtaining module 1020 includes:
a third obtaining unit, configured to obtain second animation data, the second animation data being animation data corresponding to the second style, the second attribute data including the second animation data, the second animation data being configured for replacing the first animation data.

In some examples, the third obtaining unit is configured to:
determine a first action currently performed by the virtual character in the first style; and
select, as the second animation data, animation data corresponding to the first action from a plurality of pieces of candidate animation data corresponding to the second style, different actions corresponding to different animation data.

In some examples, the obtaining module 1020 is configured to:
obtain the second attribute data in response to the switching operation in a process of controlling, by the first controller, the virtual character in the first style to move;
or
obtain the second attribute data in response to the switching operation in a process of controlling, by the first controller, the virtual character in the first style to fight.

In the technical solutions provided in the examples of this application, the virtual character in the first style is switched to the virtual character in the second style by replacing the attribute data of the virtual character without changing the controller of the virtual character. Compared with the related art in which a new controller needs to be created, and overall data of the virtual character in the second style needs to be reloaded to replace overall data of the virtual character in the first style, causing a problem of unsmooth switching in a switching process, in the examples of this application, the virtual character is controlled through the same controller before and after the switching, and the control system does not change except for a change in the style of the virtual character, thereby omitting an operation of replacing the entire control system. Therefore, the problem of unsmooth character switching may be avoided while implementing style switching of the virtual character, thereby realizing seamless switching of the virtual character between different styles, and improving a switching effect.

When the apparatus provided in the foregoing example implements the functions of the apparatus, only division of the foregoing function modules is used as an example for description. In the practical application, the functions may be allocated to and completed by different function modules as required. In other words, a content structure of the device is divided into different function modules, to complete all or some of the functions described above. In addition, the apparatus provided in the foregoing examples and the method examples belong to the same concept. For details of a specific implementation process, reference may be made to the method examples. Details are not described herein again.

FIG. 11 is a structural block diagram of a terminal device 1100 according to an example of this application. The terminal device 1100 may be any electronic device having data computing, processing, and storage functions. The terminal device 1100 may be configured to implement the virtual character switching method provided in the foregoing examples. Generally, the terminal device 1100 includes a processor 1101 and a memory 1102.

The processor 1101 may include one or more processing cores, for example, a 4-core processor or an 8-core processor. The processor 1101 may be implemented through at least one of the following hardware forms: digital signal processing (DSP), a field-programmable gate array (FPGA), and a programmable logic array (PLA). The processor 1101 may alternatively include a main processor and a coprocessor. The main processor is configured to process data in a wake-up state, which is also referred to as a central processing unit (CPU). The coprocessor is a low-power processor configured to process data in a standby state. In some examples, the processor 1101 may be integrated with a graphics processing unit (GPU). The GPU is configured to render and draw content that needs to be displayed on a display screen. In some examples, the processor 1101 may further include an artificial intelligence (AI) processor. The AI processor is configured to process computing operations related to machine learning.

The memory 1102 may include one or more computer-readable storage media. The computer-readable storage medium may be non-transient. The memory 1102 may further include a high-speed random access memory (RAM) and a nonvolatile memory, for example, one or more disk storage devices or flash storage devices. In some examples, the non-transitory computer-readable storage medium in the memory 1102 is configured to store a computer program, the computer program being configured to be executed by one or more processors to implement the foregoing virtual character switching method.

A person skilled in the art may understand that the structure shown in FIG. 11 does not constitute a limitation on the terminal device 1100, and may include more or fewer assemblies than illustrated, or combine some assemblies, or adopt different assembly arrangements.

In an example, a non-transitory computer-readable storage medium is further provided, the storage medium having a computer program stored therein, the computer program, when executed by a terminal device, implementing the foregoing virtual character switching method. In some examples, the foregoing computer-readable storage medium may be a read-only memory (ROM), a RAM, a compact disc read-only memory (CD-ROM), a magnetic tape, a floppy disk, an optical data storage device, and the like.

In an example, a computer program product is further provided, including a computer program, the computer program being stored in a computer-readable storage medium. A processor of a terminal device reads the computer program from the computer-readable storage medium, and the processor executes the computer program, to cause the terminal device to perform the foregoing virtual character switching method.

In this application, a prompt interface or a pop-up window can be displayed, or voice prompt information can be outputted before acquiring user-related data and when acquiring user-related data. The prompt interface, the pop-up window, or the voice prompt information is configured for prompting the user that user-related data is currently being acquired. In this way, related operations of obtaining the user-related data only start to be executed after obtaining a confirmation operation of the user on the prompt interface or the pop-up window. Otherwise (e.g., when the confirm operation performed by the user on the prompt interface or the pop-up window is not obtained), the related operations of obtaining the user-related data are ended. In other words, the user-related data is not obtained. In other words, information (including but not limited to user device information and user personal information), data (including but not limited to data for analysis, stored data, and displayed data), and signals involved in this application are all authorized by users or fully authorized by all parties, and acquiring, use, and processing of relevant data need to comply with relevant laws, regulations, and standards of relevant countries and regions. For example, data related to the virtual character controlled by the client in this application is obtained under full authorization.

“Plurality of” mentioned in the specification means two or more. “And/or” describes an association relationship for describing associated objects and represents that three relationships may exist. For example, A and/or B may represent the following three cases: only A exists, both A and B exist, and only B exists. The character “/” generally indicates an “or” relationship between a preceding associated object and a latter associated object. In addition, the operation numbers described in this specification merely show a possible execution sequence of the operations. In some other examples, the foregoing operations may not be performed based on the number sequence. For example, two operations with different numbers may be simultaneously performed, or two operations with different numbers may be performed based on a sequence contrary to the sequence shown in the figure. This is not limited in this application.

The foregoing descriptions are merely examples of this application, but are not intended to limit this application. Any modification, equivalent replacement, or improvement made within the spirit and principle of this application falls within the protection scope of this application.

What is claimed is:

1. A virtual character switching method, performed by a computing device, comprising:
displaying a virtual character in a first style constructed based on first attribute data, an action of the virtual character in the first style being controlled by a controller, and the first attribute data is associated with the virtual character in the first style;
obtaining second attribute data in response to a switching operation in a process of displaying the virtual character in the first style, the second attribute data is associated with the virtual character in a second style, the second style being different from the first style;
replacing the first attribute data with the second attribute data; and
switching the virtual character in the first style to the virtual character in the second style constructed based on the second attribute data, an action of the virtual character in the second style being controlled by the controller.

2. The method according to claim 1, wherein the first attribute data comprises first bone data, and the method further comprises:
obtaining the first bone data by adjusting basic bone data based on first exclusive bone data, wherein the first exclusive bone data indicates a body shape or a skeleton of the virtual character in the first style.

3. The method according to claim 2, wherein the obtaining the second attribute data comprises:
obtaining second exclusive bone data indicating the body shape or the skeleton of the virtual character in the second style; and
adjusting the basic bone data based on the second exclusive bone data, to obtain second bone data, and wherein the second attribute data comprising the second bone data.

4. The method according to claim 3, wherein the adjusting the basic bone data to obtain the second bone data comprises:
adjusting, based on a feature parameter of a first bone comprised in the second exclusive bone data, the feature parameter of the first bone comprised in the basic bone data to obtain the second bone data, and wherein
the feature parameter of the first bone being configured for specifying at least one of a size, a shape, a position, and an angle of the first bone.

5. The method according to claim 1, wherein the first attribute data comprises first model data associated with an appearance of the virtual character in the first style, wherein
the obtaining the second attribute data comprises:
obtaining second model data associated with the appearance of the virtual character in the second style, and wherein
the second attribute data comprising the second model data.

6. The method according to claim 5, wherein each appearance resource comprised in the second model data replaces each appearance resource comprised in the first model data through asynchronous loading.

7. The method according to claim 1, wherein the first attribute data comprises first animation data, the first animation data associated with the action of the virtual character in the first style, wherein
the obtaining the second attribute data comprises:
obtaining second animation data associated with the action of the virtual character in the second style, and wherein
the second attribute data comprising the second animation data.

8. The method according to claim 7, wherein the obtaining the second animation data comprises:
determining a first action currently performed by the virtual character in the first style; and
selecting, as the second animation data, animation data corresponding to the first action from a plurality of pieces of candidate animation data corresponding to the second style.

9. The method according to claim 1, wherein the obtaining the second attribute data comprises:
obtaining the second attribute data in response to the switching operation in a process of controlling, by the controller, the virtual character in the first style to move or fight with another virtual character.

10. A computing device, comprising:
one or more processors; and
memory storing instructions that, when executed by the one or more processors, cause the computing device to:
display a virtual character in a first style constructed based on first attribute data, an action of the virtual character in the first style being controlled by a controller, and the first attribute data is associated with the virtual character in the first style;
obtain second attribute data in response to a switching operation in a process of displaying the virtual character in the first style, the second attribute data is associated with the virtual character in a second style, the second style being different from the first style;
replace the first attribute data with the second attribute data; and
switch the virtual character in the first style to the virtual character in the second style constructed based on the second attribute data, an action of the virtual character in the second style being controlled by the controller.

11. The computing device according to claim 10, wherein the first attribute data comprises first bone data, and the instructions, when executed by the one or more processors, cause the computing device to:
obtain the first bone data by adjusting basic bone data based on first exclusive bone data, wherein the first exclusive bone data indicates a body shape or a skeleton of the virtual character in the first style.

12. The computing device according to claim 11, wherein the instructions, when executed by the one or more processors, cause the computing device to obtain the second attribute data by:
obtaining second exclusive bone data indicating the body shape or the skeleton of the virtual character in the second style; and
adjusting the basic bone data based on the second exclusive bone data, to obtain second bone data, and wherein the second attribute data comprising the second bone data.

13. The computing device according to claim 10, wherein the first attribute data comprises first model data associated with an appearance of the virtual character in the first style, wherein the instructions, when executed by the one or more processors, cause the computing device to obtain the second attribute data by:
obtaining second model data associated with the appearance of the virtual character in the second style, and
wherein the second attribute data comprising the second model data.

14. The computing device according to claim 13, wherein each appearance resource comprised in the second model data replaces each appearance resource comprised in the first model data through asynchronous loading.

15. The computing device according to claim 10, wherein the first attribute data comprises first animation data, the first animation data associated with the action of the virtual character in the first style, wherein the instructions, when executed by the one or more processors, cause the computing device to obtain the second attribute data by:
obtaining second animation data associated with the action of the virtual character in the second style, and wherein
the second attribute data comprising the second animation data.

16. The computing device according to claim 15, wherein when the instructions, when executed by the one or more processors, cause the computing device to obtain the second animation data by:
determining a first action currently performed by the virtual character in the first style; and
selecting, as the second animation data, animation data corresponding to the first action from a plurality of pieces of candidate animation data corresponding to the second style.

17. The computing device according to claim 10, wherein when the instructions, when executed by the one or more processors, cause the computing device to obtain the second attribute data by:
obtaining the second attribute data in response to the switching operation in a process of controlling, by the controller, the virtual character in the first style to move or fight with another virtual character.

18. A non-transitory computer-readable medium storing instructions, when executed, cause:
displaying a virtual character in a first style constructed based on first attribute data, an action of the virtual character in the first style being controlled by a controller, and the first attribute data is associated with the virtual character in the first style;
obtaining second attribute data in response to a switching operation in a process of displaying the virtual character in the first style, the second attribute data is associated with the virtual character in a second style, the second style being different from the first style;
replacing the first attribute data with the second attribute data; and
switching the virtual character in the first style to the virtual character in the second style constructed based on the second attribute data, an action of the virtual character in the second style being controlled by the controller.

19. The non-transitory computer-readable medium according to claim 18, wherein the first attribute data comprises first bone data, and the instructions, when executed, cause:
obtaining the first bone data by adjusting basic bone data based on first exclusive bone data, and wherein the first exclusive bone data indicates a body shape or a skeleton of the virtual character in the first style.

20. The non-transitory computer-readable medium according to claim 18, wherein the first attribute data comprises first model data associated with an appearance of the virtual character in the first style, wherein the instructions, when executed, cause the obtaining the second attribute data by:
obtaining second model data associated with the appearance of the virtual character in the second style, and
wherein the second attribute data comprising the second model data.
